(19) United States
(12) Patent Application Publication
(10) Pub. No.: US 2026/0333501 A1
(43) Pub. Date: Oct. 22, 2026

(54) CONFIGURATION FOR GAP FOR MUSIM CAPABLE UE

(71) Applicant: APPLE INC., Cupertino, CA (US)

(72) Inventors: Qiming Li, Beijing (CN); Yang Tang, San Jose, CA (US); Dawei Zhang, Saratoga, CA (US); Jie Cui, San Jose, CA (US); Manasa Raghavan, Sunnyvale, CA (US); Xiang Chen, Campbell, CA (US); Yuexia Song, Beijing (CN); Rolando E Bettancourt Ortega, Munich (DE)

(21) Appl. No.: 19/107,726

(22) PCT Filed: Sep. 23, 2022
(86) PCT No.: PCT/CN2022/120912

§ 371 Date: Feb. 28, 2025

(51) Int. Cl. H04W 76/27; H04W 36/00; H04W 36/14; H04W 76/28; H04W 88/06

(52) U.S. Cl. CPC H04W 76/27; H04W 36/0058; H04W 36/0072; H04W 36/1443; H04W 76/28; H04W 88/06

(57) ABSTRACT

The disclosure relates to system and method for including configuration for gap for MUSIMs (multi-Universal Subscriber Identity Modules) capable user equipment (UE). In some aspect, the UE comprises at least one antenna, at least one radio coupled to the at least one antenna, and a processor coupled to the at least one radio. The UE supports multi-USIM includes at least a first SIM associated with a first network and a second SIM associated with a second network. The at least one radio and the processor are configured to request, from the first network, a gap configuration associated with an operation in the second network, the gap configuration including a gap during which the operation in the second network is performed by the UE; receive, from the first network, an indication of the gap configuration; and perform, during each gap within an operation period, operation in the second network based on the gap configuration, when the UE is in a Radio Resource Control (RRC) connected state with the first network and is in a RRC idle state or RRC inactive state with the second network, the operation period comprising at least one gap. The processor is further configured to lengthen the operation period if the gap within the operation period is dropped at the UE due to a collision of the gap with other gaps.

### TECHNICAL FIELD

This application relates generally to wireless communication systems, including user equipments (UEs), network devices, methods, apparatus, and medium, including configuration for gap for MUSIMs (multi-Universal Subscriber Identity Modules) capable UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that have been used, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to user equipments (UEs), network devices, methods, apparatus, and medium for configuration for gap for MUSIMs capable UE.

In some aspects, the UE comprises at least one antenna, at least one radio coupled to the at least one antenna, and a processor coupled to the at least one radio. The UE supports multi-USIM includes at least a first SIM associated with a first network and a second SIM associated with a second network. The at least one radio and the processor are configured to request, from the first network, a gap configuration associated with an operation in the second network, the gap configuration including a gap during which the operation in the second network is performed by the UE; receive, from the first network, an indication of the gap configuration; and perform, during each gap within an operation period, operation in the second network based on the gap configuration, when the UE is in a Radio Resource Control (RRC) connected state with the first network and is in a RRC idle state or RRC inactive state with the second network, the operation period comprising at least one gap. The processor is further configured to lengthen the operation period if the gap within the operation period is dropped at the UE due to a collision of the gap with other gaps.

In some aspects, a network device associated with a first network is provided. The network device comprises at least one antenna, at least one radio coupled to the at least one antenna, and a processor coupled to the at least one radio. The at least one radio and the processor are configured to: receive, from an UE, a request for a gap configuration associated with an operation in a second network, the gap configuration including a gap during which the operation in the second network is performed by the UE, and transmit, to the UE, an indication of the gap configuration. The operation period is lengthened by the UE if the gap within the operation period is dropped at the UE due to a collision of the gap with other gaps.

In some aspects, methods performed by the user equipment (UE) as previously recited are provided.

In some aspects, methods performed by the network device as previously recited are provided.

In some aspects, apparatus for operating a user equipment (UE) are provided, and the apparatus comprises one or more processors to cause a user equipment (UE) device to perform the above methods.

In some aspects, apparatus for operating a network device are provided, and the apparatus comprises one or more processors to cause the network device to perform the above methods.

In some aspects, non-transitory computer readable memory mediums storing program instructions are provided, and the instructions can be executable by one or more processors to cause a user equipment (UE) device to perform the above methods.

In some aspects, non-transitory computer readable memory mediums storing program instructions are provided, and the instructions can be executable by one or more processors to cause a network device to perform the above methods.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example architecture of a wireless environment in which a MUSIM device operates, according to embodiments disclosed herein.

FIG. 4 illustrates a flowchart diagram for an example method at UE side for configuration for gap for MUSIMs capable UE, according to embodiments disclosed herein.

FIG. 5 illustrates an example time chart showing the relations between the operation period, the gap length and the gap repetition period, according to embodiments disclosed herein.

FIG. 6A illustrates an example time chart showing the relations between the operation period, the gap length, the gap repetition period and the operation window, according to embodiments disclosed herein.

FIG. 6B illustrates an example time chart showing the lengthened operation period due to dropped gap, according to embodiments disclosed herein.

FIG. 6C illustrates an example time chart showing the lengthened operation period due to dropped gap, according to other embodiments disclosed herein.

FIG. 7 illustrates a flowchart diagram for an example method 700 at network A side for configuration for gap for MUSIMs capable UE, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

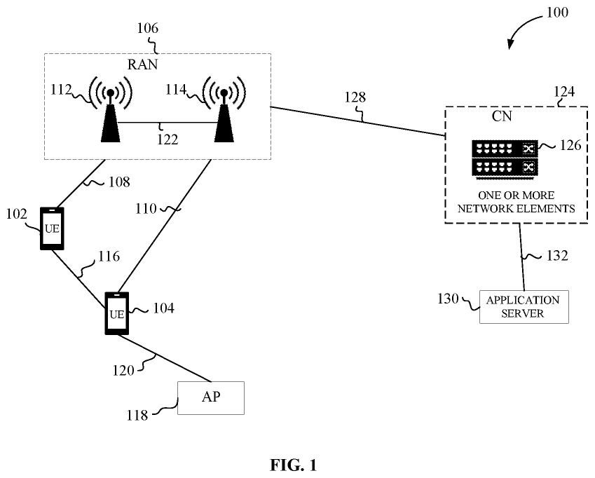

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

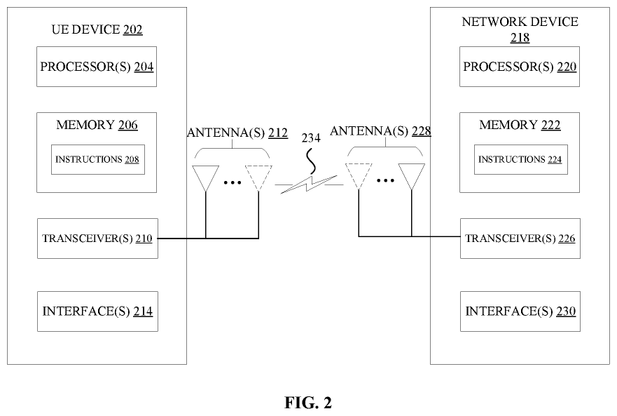

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

Hereinafter, the three possible RRC states in a wireless communication system (i.e., RRC_IDLE, RRC_CONNECTED and/or RRC_INACTIVE) are described.

In RRC_IDLE state (or, idle mode/state), RRC context for communication between a UE and a network may not be established in RAN, and the UE may not belong to a specific cell. Also, in RRC_IDLE state, there is no core network connection for the UE. Since the device remains in sleep mode in most of the time to reduce battery consumption, data transfer between the UE and the network may not occur. UEs in RRC_IDLE may periodically wake-up to receive paging messages from the network. Mobility may be handled by the UE through cell reselection. Since uplink synchronization is not maintained, the UE may not perform uplink transmission other than transmissions for random access (e.g., random access preamble transmission) to move to RRC_CONNECTED.

In RRC_CONNECTED state (or, connected state/mode), RRC context for communication between a UE and a network may be established in RAN. Also, in RRC_CONNECTED, core network connection is established for the UE. Since the UE belongs to a specific cell, cell-radio network temporary identifier (C-RNTI) for signalings between the UE and the network may be configured for the UE. Data transfer between the UE and the network may occur. Mobility may be handled by the network—that is, the UE may provide measurement report to the network, and the network may transmit mobility commands to the UE to perform a mobility. Uplink time alignment may need to be established based on a random access and maintained for data transmission.

In RRC_INACTIVE state (or, inactive state/mode), RRC context for communication between a UE and a network may be kept in RAN. Data transfer between the UE and the network may not occur. Since core network connection may also be kept for the UE, the UE may fast transit to a connected state for data transfer. In the transition, core network signalling may not be needed. The RRC context may be already established in the network and idle-to-active transitions can be handled in the RAN. The UE may be allowed to sleep in a similar way as in RRC_IDLE state, and mobility may be handled through cell reselection without involvement of the network. The RRC_INACTIVE state may be construed as a mix of the idle state and the connected state.

The UE may transit to RRC_CONNECTED state from RRC_IDLE state by performing initial attach procedure or RRC connection establishment procedure. The UE may transit to RRC_IDLE state from RRC_CONNECTED state when detach, RRC connection release (e.g., when the UE receives RRC release message) and/or connection failure (e.g., radio link failure (RLF)) has occurred. The UE may transit to RRC_INACTIVE state from RRC_CONNECTED state when RRC connection is suspended (e.g., when the UE receives RRC release message including a suspend configuration), and transit to RRC_CONNECTED state from RRC_INACTIVE state when RRC connection is resume by performing RRC connection resume procedure. The UE may transit to RRC_IDLE state from RRC_INACTIVE state when connection failure such as RLF has occurred.

Hereinafter, discontinuous reception (DRX) is described.

A UE may use DRX in RRC_IDLE and RRC_INACTIVE state in order to reduce power consumption. A DRX cycle may be periodically recurred, and comprise a DRX ON duration in which the UE wakes up, and a DRX OFF duration in which the UE sleeps. Since the DRX cycle is periodically recurred, the DRX ON duration and the DRX OFF duration may also be periodically recurred according to the DRX cycle.

Hereinafter, contents related to a multi-universal subscriber identity module (MUSIM) is described.

Nowadays, as the development of the communication technology, MUSIM capable UEs have been more and more popular. The user may have both a personal and a business subscription in one UE or has two personal subscriptions in one UE for different services.

FIG. 3 illustrates an example architecture of a wireless environment in which a MUSIM device operates, according to embodiments disclosed herein.

Referring to FIG. 3, a MUSIM UE 300 may have a plurality of universal subscriber identity modules (USIMs)—SIM A 301 and SIM B 302. The MUSIM UE 300 may register to a network A (NW A) 310 based on subscription information in the SIM A 301 to obtain a connection A 311 between the network A 310 and the MUSIM UE 300. The MUSIM UE 300 may also register to a network B (NW B) 320 based on subscription information in the SIM B 302 to obtain a connection B 321 between the network B 320 and the MUSIM UE 300. The MUSIM UE 300 may use the SIM A 301 to perform a communication with the network A 310 over the connection A 311, and use the SIM B 302 to perform a communication with the network B 320 over the connection B 321. SIM A 301 and SIM B 302 may belong to same or different operators, and may be a physical SIM or embedded SIM (eSIM). Note that the number of the SIMs in FIG. 3 is only exemplary, and the MUSIM UE 300 may have more than two SIMs.

The UE 300 that are registered to two networks need to be able to operate on two networks. In order to use the hardware efficiently and economically and/or dependent on the UE capabilities (e.g., Rx and Tx capabilities), the hardware capabilities of the UE 300 are shared by at least two SIMs, and the related capabilities need to be dynamically split between the two SIMs. This can lead to a temporary hardware conflict for the UE. For example, when SIM A 301 is in Radio Resource Control (RRC) connected state in NW A 310 while SIM B 302 is in RRC Idle or RRC Inactive in NW B 320, the two RF chains of the UE 300 will be occupied by SIM A 301 for the communication in NW A 310, and thus the UE 300 cannot operate (e.g., performing RRM measurement, paging reception) on SIM B 302. Further, the temporary hardware conflict for the UE may require the UE to release some resources from one SIM and use them on another SIM. For example, one of the RF chains of the UE 300 needs to be switched to SIM B 302, such that the UE 300 may operate on the NW B 320 associated with SIM B 302. In this case, if the NW A 310 is not aware of the UE's reduced capability in RF chain, there may be data loss due to demodulation failure and wasting radio resources in NW A 310.

In order to solve at least one of the above problem, gap particularly for MUSIM purpose were introduced. The idea of gap is to create a small gap, during which neither transmission nor reception occurs on one network, and thus the UE can perform the corresponding operation in the measurement gap on another network and then switch back. In particular, NW A 310 will provide gap for the UE 300 to perform operations in NW B 320.

The operation may include any kinds of operation which can be performed by means of the gap/interruption. For example, the operation comprises RRM measurement, paging reception, S1 reception and so on. The measurement operation can be performed during any appropriate kinds of wireless communication operation, including such as cell switch and/or access, Carrier Aggregation including at least carrier switching and management, load aggregation, etc., at any appropriate phase/stage during the wireless communication, including such as initialization, status transition, etc., and can be utilized to measure any desired signal/parameter/indicator which may be for example, performance related, including such as SSB, PRS, etc.

The UE can be configured with multiple gaps, which, for example, may include periodic gaps and/or aperiodic gaps. In some examples, a UE can be configured with two concurrent gaps. In some other examples, for a case of MUSIM capable UE, the UE can be configured with no more than three periodic MUSIM gap and/or one aperiodic MUSIM gap for MUSIM. Note that the number of gaps as described above are only exemplary, and are not so limited.

However, how to perform operations in NW B in terms of the MUSIM gaps has not yet been specified. Therefore, it is still desired to improve the configuration for MUSIM gaps to enhance operations in the MUSIM case, for example, to guarantee network performance on NW A and NW B.

Hereinafter some embodiments will be described with reference to figures. Wherein, the description may be mainly based on a specific type of gap, that is, measurement gap, however, the description and thereby the concept of the present disclosure can be equivalent to any other appropriate type of gaps.

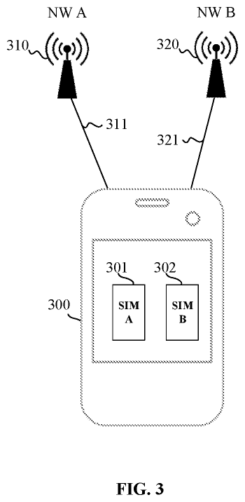

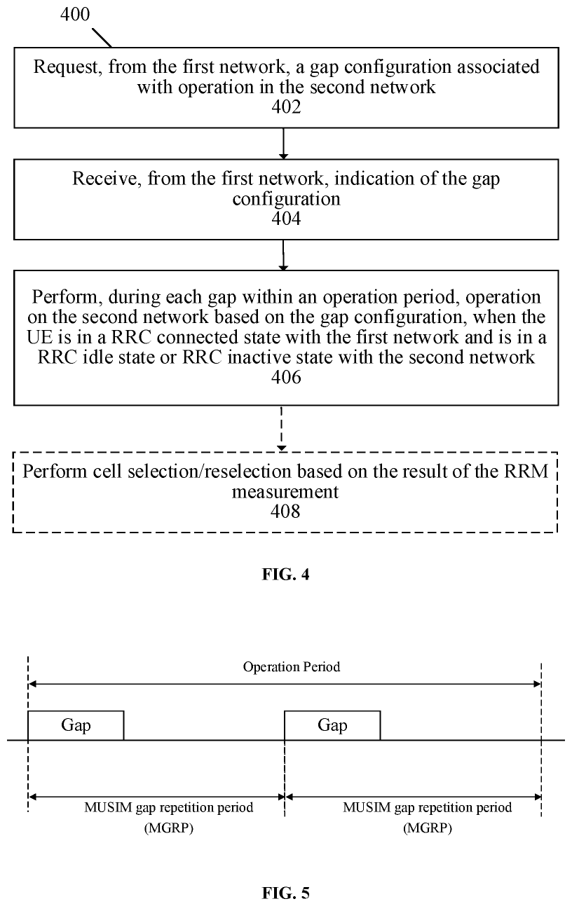

FIG. 4 illustrates a flowchart diagram for an example method 400 at UE side for configuration for gap for MUSIMs capable UE, according to embodiments disclosed herein. Aspects of the method of FIG. 4 may be implemented by a wireless device such as the UE 102, the UE 104 and the wireless device 202 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 4 may operate as follows.

At 402, the UE requests, from the first network (NW A), a gap configuration associated with operation in the second network (NW B).

The first network may not be aware of the requirement for the UE to perform operations in the second network, and thus the UE can send the requests for the gap configuration to the first network. The request can be sent to any appropriate party in the first network, such as the first network-side device, a controlling device in the first network, a Transmission-Reception Point (TRP), and so on.

The gap configuration includes a gap during which an operation in the second network is performed by the UE.

According to some embodiments, the gap configuration can include information related to the gap during which an operation in the second network is performed by the UE. In some embodiments, the gap configuration may correspond to one gap pattern. In some embodiments, a gap pattern may indicate the characteristic of a type of gap which can be utilized for performing specific operation. In particular, the gap pattern can have corresponding gap characteristics, including at least one of gap identity, time duration (MUSIM Gap Length, MGL) and periodicity of the gap (MUSIM Gap Repetition Period, MGRP), start and end of the gap (e.g., gap offset and gap timing advance), the frequency segment in which the gap is located, the operation or object by using the gap, etc. Usually, when there exist multiple gaps, each gap may have a corresponding gap configuration. On the other hand, all gap configurations can constitute a whole gap configuration for the UE. When there exist multiple gaps, there may exist multiple gap configurations correspondingly, which can have similar or different form/items.

The above exemplary gap configuration specifically defines the characteristic of gaps, and when there exist multiple gaps, the gap configuration may specifically define the characteristic of respective gaps. Of course, the gap configuration for multiple gaps can be in any other appropriate form/format.

For example, the gap configuration may include gap pattern index/indicator indicating a gap pattern, and based on the gap pattern index/indicator, the gap characteristic of gap pattern can be directly derived. In such a case, the gap configuration can indicate association/mapping between the measurement gap pattern index/indicator and working frequency segment index/indicator. And the wireless device when receiving the gap pattern index/indicator, can obtain the gap characteristic of gap pattern locally or from other appropriate party.

According to some embodiments, as to a specific type of gap, i.e., measurement gap, the gap pattern includes time duration of the measurement gap (MUSIM Gap Length, MGL) and periodicity of the measurement gap (MUSIM Gap Repetition Period, MGRP). For example, for a specific gap pattern, the MGL may have the value selected from 3, 4, 6, 10 and 20 milliseconds (ms), and the MGRP may have the value selected from 20, 40, 80, 160, 320, 640, 1280, 2560, and 5120 ms. Of course, the MGL and MGRP can have any other appropriate values, and the values of the MGL and MGRP can be combined with each other according to the actual requirement for the gap pattern.

According to some embodiments, information about priority of gap is also incorporated into the gap pattern or gap configuration. In particular, the priority of gap may actually indicate the priority for performing operation to be performed at the gap when the gap collides with other gaps, i.e., when the gap overlaps with other gaps. For example, in case of collision between two gap occasions, the operation related to the gap with higher priority will be performed, while operations of other gaps will be dropped. In some embodiments, the priority can be given by any appropriate presentation, such as a positive numerical value, wherein the larger the value is, the higher the priority is. Of course, any other appropriate presentation or expression can be utilized to indicate the priority, as known in the art, and will not be described in detail herein. Further, any appropriate manner of determining the appropriate priority of each gap configuration can be utilized, as known in the art, and will not be described in detail herein.

At step 404, the UE receives, from the first network (NW A), an indication of the gap configuration associated with the operation in the second network (NW B).

According to the present disclosure, the wireless device can acquire the gap configuration in a variety of manners. According to some embodiments, the gap configuration per se can be provided by the first network directly. According to some embodiments, the gap configuration can be derived by the wireless device per se, for example, the wireless device can obtain any appropriate information indicating the gap configuration, such as index of gap configuration, other information available for deriving the configuration, etc., from the first network and the wireless device can derive the configuration based on the information, such as by look-upping table. In some embodiments, the gap configuration or the information for deriving the configuration can be provided by the first network by RRC Reconfiguration message, for example, using MeasGapConfig signaling.

At step 406, the UE perform, during each gap within an operation period, operation in the second network based on the gap configuration, when the UE is in a Radio Resource Control (RRC) connected state with the first network and is in a RRC idle state or RRC inactive state with the second network.

In particular, the wireless device can perform operations based on the gap configuration may means that the operation can be performed based on gap patterns or characteristic of gaps indicated in the gap configuration. For a gap, the corresponding gap pattern may mean characteristics of the gap, such as time duration, period, frequency attributes, and so on. For example, for a gap, a corresponding operation can be performed in accordance with the period of the gap, and particularly, in the duration of occasion of the gap.

According to some embodiments, the operation for a gap may comprise a kind of operation depending on the type or characteristic of the gap. In particular, depending on the types of the gaps, the operation performed in the gaps may be different from each other. For example, for a measurement gap, a measurement operation will be predetermined, such as the measurement object will be predetermined, and such measurement operation will perform in accordance with the measurement gap pattern. In addition to a measurement gap, other types of gaps may include Pre-configured measurement gap (Pre-MG), Network controlled small gap (NCSG), Gap for Non-Terrestrial Network (NTN gap), Gap for positioning (PosGap), and for each type of gap, corresponding operation can be predefined and performed in the gap occasion.

When the UE is in a Radio Resource Control (RRC) connected state with the first network (NW A) and is in a RRC idle state or RRC inactive state with the second network (NW B), the UE may wake-up in NW B to perform operation in NW B. For example, the UE may perform RRM measurement on NW B which is required for cell selection and/or reselection. Further, the UE may also periodically wake-up in NW B to receive paging messages from the NW B. However, since the UE is in a RRC connected state with NW A, these operations may be performed during the gap in order to guarantee network performance on NW A.

According to some embodiments, the operation period can comprise at least one gap and is determined according to the characteristics of the operation and the gap configuration associated with the operation. For example, the length of the operation period is basically determined such that the operation can be achieved during the operation period. For some operations, the operation period can have a periodicity such that the operation can be performed periodically.

During the operation period, the UE performs operation in the second network within the gap length (MGL) every gap repetition period (MGRP). According to some embodiments, when the MGRP is shorter than the operation period, the operation period can comprise more than one gap. FIG. 5 illustrates an example time chart showing the relations between the operation period, the gap length and the gap repetition period, according to embodiments disclosed herein. As shown in FIG. 5, the operation period comprises two MGRP and two gaps. Of course, the time chart shown in FIG. 5 is only exemplary, and the relations between the operation period, MGL and MGRP can be modified appropriately according to the actual requirement.

As discussed above, the gap may collide with other gaps, and in case of collision between two gaps, the operation related to the gap with higher priority will be performed, while operations of other gaps will be dropped. Thus, during the operation period, there may be one or more gaps being dropped by the UE. In such a case, the operation in the second network may be affected or even cannot be completed.

In considering above, according to some embodiments, the UE can lengthen the operation period based on the gap which is dropped at the UE due to a collision of the gap with other gaps. With such configuration, the effect on the operation due to the dropped gap can be compensated and thus facilitate the complete of the operation.

In some embodiments, the UE can simply lengthen the operation period by one or more MGRP for every gap which is dropped during the operation period. With such configuration, the effect caused by each dropped gap can be compensated.

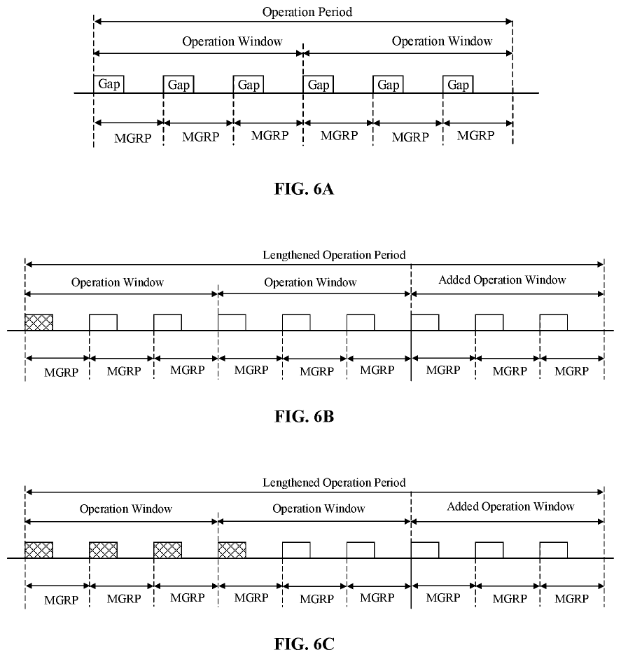

In some embodiments, an operation window within the operation period is defined as the basis unit for counting the dropped gap, and the operation period is a multiple of the operation window. The operation window is longer than or equal to the MGRP of the gap and thus each operation window comprises at least one gap. In some embodiments, the operation window is a multiple of a periodicity of the gap (MGRP). FIG. 6A illustrates an example time chart showing the relations between the operation period, the gap length, the gap repetition period and the operation window, according to embodiments disclosed herein. As shown in FIG. 6A, the operation period comprises two operation window and each operation window comprises three MGRP.

For the operation window which is equal to the MGRP of the gap and thus comprises only one gap, if the gap within the operation window is dropped, similar to the above embodiment, the UE can simply lengthen the operation period by one or more MGRP for every operation window with the gap therein dropped.

For the operation window which is greater than the MGRP of the gap and thus comprises more than one gap, the UE can lengthen the operation period by one or more operation window for every operation window with at least one gap therein dropped. FIG. 6B illustrates an example time chart showing the lengthened operation period due to dropped gap, according to embodiments disclosed herein. As shown in FIG. 6B, in the first operation window, the first gap is dropped. Thus, the UE lengthens the operation period by one operation window for the first operation window. With this configuration, the operation period is lengthened if one gap within the operation window is dropped, and thus it is not necessary to determine whether the other gaps in the same operation window are dropped. Therefore, the workload of the UE can be reduced.

Alternatively, the UE can lengthen the operation period by one or more operation window only for every operation window with all the gap therein dropped. FIG. 6C illustrates an example time chart showing the lengthened operation period due to dropped gap, according to other embodiments disclosed herein. As shown in FIG. 6C, in the first operation window, all the three gaps are dropped, and in the second operation window, only the first gap is dropped. Thus, the UE lengthens the operation period by one operation window only for the first operation window, and neglects the dropped gap in the second operation window. With this configuration, the operation period is lengthened only if all the gaps within one operation window are dropped, and thus the operation period will not be over-lengthened. Therefore, the resource cost by the operation will be limited.

By defining the operation window, it is beneficial to modify the way to lengthen the operation period in a more flexible manner.

In some embodiments, the UE can stop lengthening the operation period if the number of groups of operation window during which one or more gap is dropped is larger than a predetermined maximum number. If the several gaps are dropped within the operation period, the operation period may be lengthened to a relative long period, which may adversely affect the communication on NW A. Further, if the gaps are dropped consecutively, it may indicate that the gap configuration of this gap is not correct and the operation in this gap cannot be performed. Therefore, an upper limit can be set to the operation period by defining a maximum number for the number of groups of operation window during which one or more gap is dropped. If the number of groups of operation window during which one or more gap is dropped exceeds the maximum number, the operation period is no longer lengthened and the operation in the gaps on NW B can be stopped. With this configuration, the adverse effect on the communication on NW A will be reduced.

Finally and optionally, at step 408, the UE performs cell selection/reselection based on the result of the RRM measurement. This step can be omitted if no cell selection/reselection is to be performed by UE.

Hereinafter some exemplary embodiments according to the present disclosure will be described, where the exemplary embodiments relate to the operation in NW B during the gap. Note that the exemplary embodiments are described mainly based on measurement gap including measurement gap length (MGL) and MUSIM Gap Repetition Period (MGRP), but such description is not limitative, and the concept of the present disclosure can be equivalently utilized to other types of gaps.

### RRM Measurement on Serving Cell in NW B

Hereinafter, the first embodiment according to the present disclosure will be described, and in this embodiment, the operation in NW B during the gap is the RRM measurement on a serving cell in NW B.

In RRC Idel state, the UE shall measure the Synchronization Signal based Reference Signal Received Power (SS-RSRP) and Synchronization Signal based Reference Signal Received Quality (SS-RSRQ) level of the serving cell in NW B and evaluate the cell selection criterion S for the serving cell in T_{serv_MUSIM}. The cell selection criterion S and the way of evaluating the cell selection criterion S for the serving cell are well-known in this art and will not be described in this disclosure.

The expression of T_{serv_MUSIM} is provided in the below Table 1.

TABLE 1

| max (DRX | | |
|---|---|---|
| cycle, MGRP) | Scaling Factor (N1) | Tₛₑᵣᵥ_{_{—}}_{MUSIM} |

| [s] | FR1 | FR2 | [s] |
|---|---|---|---|
| 0.32 | 1 | 8 | 0.32*N1*M1*(4 + Ns) |
| 0.64 | | 5 | 0.64*N1*M1*(4 + Ns) |
| 1.28 | | 4 | 1.28*N1*M1*(2 + Ns) |
| 2.56 | | 3 | 2.56*N1*M1*(2 + Ns) |

In this embodiment, the T_{serv_MUSIM} corresponds to the “operation period” as discussed above, and N1*max(DRX cycle, MGRP) corresponds to the “operation window” as discussed above. N1 is a scaling factor determined based on the frequency range adopted by the serving cell of the NW B and the max (DRX cycle, MGRP) as shown in the Table 1. The value of N1 can be 1 for FR1, and 8, 5, 4 and 3 for FR2 depending on the value of the max (DRX cycle, MGRP). Further, the values of N1 shown in the Table 1 associated with FR2 applies for UE supporting power class 2&3&4, and for UE supporting power class 1 or 5, the value of N1 associated with FR2 equals to 8 for all the values of the max (DRX cycle, MGRP).

The parameter max (DRX cycle, MGRP) refers to the largest one of a DRX cycle length and the MGRP length. The DRX is the DRX of the serving cell configured by NW B, and the MGRP belongs to the MUSIM gap pattern associated with RRM measurement on serving cell in NW B. Normally, the DRX cycle length is a multiple of the MGRP length if the MGRP length is smaller than the DRX cycle length. Thus, the parameter max (DRX cycle, MGRP) is a multiple of the MGRP no matter whether MGRP length is longer than DRX cycle length, i.e., the operation window is a multiple of a periodicity of the gap. Further, a ratio between the operation window and the periodicity of the gap is determined based on a frequency range of the target cell of the second network, the DRX cycles of a target cell of the second network and the MGRP. In some embodiments, the operation window is a multiple (N1 times) of a maximum of a periodicity of the gap and the DRX cycles.

As can be seen from the Table 1, T_{serv_MUSIM} is a multiple of N1*max(DRX cycle, MGRP), i.e., the operation period is a multiple of an operation window. In particular, for the max (DRX cycle, MGRP) having a value of 0.32 and 0.64 seconds, the ratio between the operation window (N1*max(DRX cycle, MGRP)) and the operation period (T_{serv_MUSIM}) is M1*(4+Ns). Further, for the max (DRX cycle, MGRP) having a value of 1.28 and 2.56 seconds, the ratio between the operation window (N1*max(DRX cycle, MGRP)) and the operation period (T_{serv_MUSIM}) is M1*(2+Ns). Further, the value of M1 is determined based on a Synchronization Signal Block (SSB) based Measurement Timing configuration (SMTC) periodicity of the target cell of the second network. In particular, M1=2 if SMTC periodicity (T_{SMTC}) >20 ms and DRX cycle ≤0.64 second, otherwise M1=1.

The value Ns is a number of groups of operation window (N1*max(DRX cycle, MGRP)) during which one or more gaps are dropped during the operation period (T_{serv_MUSIM}). Further, in some embodiments, Ns is a number of groups of operation window (N1*max(DRX cycle, MGRP)) during which all the gaps are dropped during the operation period (T_{serv_MUSIM}). If there is no gap dropped in all the operation windows during the operation period, Ns equals to 0.

In some embodiments, the value of Ns has a maximum number (Ns, max), and the UE stops lengthening the operation period if the value of Ns is larger than the maximum number (N_{s,max}). In an embodiment, the maximum number is determined based on a DRX cycles of a target cell of the second network. In particular, N_{s,max}=8 for DRX cycle length <1.28 s, and N_{s,max}=4 for DRX cycle length ≥1.28 s.

In some embodiments, the UE can perform RRM measurement on the serving cell in the second network at least once every limitation period in the operation period. The limitation period is provided to limit the interval between each RRM measurement, such that the neighboring RRM measurement will not be separated too far away from each other. In an embodiment, the limitation period can be set as 3*M1*N1 DRX cycles. The expression of the limitation period is determined based on experiment, the specific requirement of the UE and the knowledge of the inventor. In an embodiment, the limitation period is shorter than or equal to the operation period since the limitation period will not have limitation on the measurement if it is longer than the operation period. In this embodiment, the limitation period can be min (3*M1*N1 DRX cycles, T_{serv_MUSIM}), i.e., the minimum of the 3*M1*N1 DRX cycles and T_{serv_MUSIM}.

The specific numerals provided in the above embodiments are exemplary values, which are determined based on experiment, the specific requirement of the UE and the knowledge of the inventor, and the present disclosure is not so limited.

If the UE has evaluated according to the Table 1 in T_{serv_MUSIM} that the serving cell can fulfil the cell selection criterion S, the UE can perform cell selection by keeping the current serving cell. If the UE has evaluated according to the Table 1 in T_{serv_MUSIM} that the serving cell does not fulfil the cell selection criterion S, the UE shall initiate the measurements of all neighbour cells indicated by the serving cell in NW B, regardless of the measurement rules currently limiting UE measurement activities.

The UE can perform RRM measure on intra-frequency cell and/or inter-frequency cell, and the criteria for determined the cell to be measured is well-known in this art and will not be described in this disclosure.

### RRM Measurement on Intra-Frequency Neighbor Cell in NW B

Hereinafter, the second embodiment according to the present disclosure will be described, and in this embodiment, the operation in NW B during the gap is the RRM measurement on intra-frequency neighbor cell in NW B.

The UE shall be able to identify new intra-frequency cells with in NW B and perform SS-RSRP and SS-RSRQ measurements of the identified intra-frequency cells.

The UE shall be able to evaluate whether a newly detectable intra-frequency cell in NW B meets the reselection criteria within T_{detect,Intra_MUSIM}, and if so, the UE shall reselect that cell. In some embodiments, a T_{reselection, ntra_MUSIM} timer can be provided and the UE shall evaluate this intra-frequency cell for the T_{reselection, intra_MUSIM}, to determined if this cell remains satisfied with the reselection criteria within this duration, and if so, the UE shall reselect that cell.

In addition, the UE shall measure SS-RSRP and SS-RSRQ at least every T_{measure,Intra_MUSIM} for intra-frequency cells that are identified and measured according to the measurement rules.

Moreover, for an intra-frequency cell that has been already detected, but that has not been reselected to, the UE shall be capable of evaluating whether the intra-frequency cell has met reselection criterion within T_{evaluate,Intra_MUSIM}.

The reselection criteria for intra-frequency cells and the way of detecting, measuring and evaluating the intra-frequency cell are well-known in this art and will not be described in this disclosure.

The expression of T_{detect,Intra_MUSIM}, T_{measure,Intra_MUSIM}, and T_{evaluate,Intra_MUSIM} is provided in the below Table 2.

TABLE 2

| max (DRX | Scaling | | | | |
|---|---|---|---|---|---|
| cycle, MGRP) | Factor (N1) | | T_{detect, Intra}_{_{—}}_{MUSIM} | T_{measure, Intra}_{_{—}}_{MUSIM} | T_{evaluate, intra}_{_{—}}_{MUSIM} |
| [s] | FR1 | FR2 | [s] | [s] | [s] |
| 0.32 | 1 | 8 | 0.32*N1*M2*(36 + Nd) | 0.32*N1*M2*(4 + Nm) | 0.32*N1*M2*(16 + Ne) |
| 0.64 | | 5 | 0.64*N1*M2*(28 + Nd) | 0.64*N1*M2*(2 + Nm) | 0.64*N1*M2*(8 + Ne) |
| 1.28 | | 4 | 1.28*N1*M2*(25 + Nd) | 1.28*N1*M2*(1 + Nm) | 1.28*N1*M2*(5 + Ne) |
| 2.56 | | 3 | 2.56*N1*M2*(23 + Nd) | 2.56*N1*M2*(1 + Nm) | 2.56*N1*M2*(3 + Ne) |

In this embodiment, T_{detect,Intra_MUSIM}, T_{measure,Intra_MUSIM}, and T_{evaluate,Intra_MUSIM} corresponds to the “operation period” as discussed above, respectively. In particular, T_{detect, Intra_MUSIM} refers to a period for the UE to detect an intra-frequency neighbor cell that is newly detectable in the second network, T_{measure, Intra_MUSIM} refers to a period for the UE to measure an intra-frequency neighbor cell that is identified and measured in the second network, and T_{evaluate, Intra_MUSIM} refers to a period for the UE to evaluate an intra-frequency neighbor cell that has been detected in the second network.

Further, similar to the above embodiments, N1*max(DRX cycle, MGRP) corresponds to the “operation window” as discussed above. The term N1 and the term max (DRX cycle, MGRP) have the similar definition as those in the above embodiments, which will not be repeated here. The term M2 has the similar definition as M1 in the above embodiments and is also determined based on SMTC periodicity of the intra-frequency cell of the NW B. In a specific embodiment, M2=1.5 if SMTC periodicity of measured intra-frequency cell >20 ms; otherwise M2=1.

Similar to the Ns in the above embodiments, Nd, Nm and Ne also refers to the number of groups of operation window during which one or more gap is dropped during the corresponding operation period T_{detect,Intra_MUSIM}, T_{measure,Intra_MUSIM}, and T_{evaluate,Intra_MUSIM}.

Similar to the above embodiments, Nd, Nm and Ne also have corresponding maximum numbers N_{d,max}, N_{m,max} and N_{e,max}, and the UE stops lengthening the operation period if the value of one of Nd, Nm and Ne are larger than the corresponding maximum number. In an embodiment, the maximum numbers are determined based on a DRX cycles of a target cell of the second network. In particular, N_{m,max}=16 for DRX cycle length=0.32 s; N_{m,max}=8 for DRX cycle length=0.64 s; N_{m,max}=4 for DRX cycle length=1.28 s; N_{m,max}=4 for DRX cycle length=2.56 s. Further, N_{d,max}=4*N_{m,max} and N_{e,max}=2*N_{m, max}.

Some of the discussions with reference to Table 1, if applicable, can be adopted for Table 2 and will not be repeated here.

### RRM Measurement on Inter-Frequency Neighbor Cell in NW B

Hereinafter, the third embodiment according to the present disclosure will be described, and in this embodiment, the operation in NW B during the gap is the RRM measurement on inter-frequency neighbor cell in NW B.

The UE shall be able to identify new inter-frequency cells with in NW B and perform SS-RSRP and SS-RSRQ measurements of the identified inter-frequency cells.

The process of RRM measurement on inter-frequency cells is similar to that on intra-frequency cell, except that when there are several inter-frequency carriers to be measured, the operation period equal to the sum of the operation periods of the RRM measurement on each inter-frequency carrier.

In particular, the operation period comprises:
a period for the UE to detect an inter-frequency neighbor cell that is newly detectable in the second network (T_{detect, Inter_MUSIM}) and a number of inter-frequency carriers indicated by the serving cell in NW B (K_{carrier_MUSIM}), i.e., K_{carrier_MUSIM}*T_{detect,Inter_MUSIM}, a period for the UE to measure an inter-frequency neighbor cell that is newly detectable in the second network (T_{measure, Inter_MUSIM}) and a number of inter-frequency carriers indicated by the serving cell in NW B (K_{carrier_MUSIM}), i.e., K_{carrier_MUSIM}*T_{measure,Inter_MUSIM}, and
a period for the UE to evaluate an inter-frequency neighbor cell that is newly detectable in the second network (T_{evaluate,Inter_MUSIM}) and a number of inter-frequency carriers indicated by the serving cell in NW B (K_{carrier_MUSIM}), i.e., K_{carrier_MUSIM}*T_{evaluate,Inter_MUSIM}.

The formats of T_{detect, Inter_MUSIM}, T_{measure, Inter_MUSIM}, and T_{evaluate,Inter_MUSIM} are the same as those of T_{detect,Intra_MUSIM}, T_{measure,Intra_MUSIM}, and T_{evaluate,Intra_MUSIM} in Table 2 and will not be repeated here.

The reselection criteria for inter-frequency cells and the way of detecting, measuring and evaluating the inter-frequency cell are well-known in this art and will not be described in this disclosure.

Based on the result of the RRM measurement on Intra-Frequency Neighbor Cell and Inter-Frequency Neighbor Cell in NW B, the UE can perform cell reselection on the second network for the second SIM.

In some embodiment, the UE shall keep monitoring paging from NW B within the MUSIM gap associated to paging reception. If the MUSIM gap associated to paging reception is dropped, e.g. due to colliding with other gap occasions with higher priority, UE may cause interruption in paging reception in NW B. UE shall be able to receive paging in NW B within the MUSIM gap occasions which are not dropped due to, for example, gap collision.

Embodiments contemplated herein include an apparatus comprising means to perform one or more elements of the methods 400. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 400. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 400. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 400. This apparatus may be, for example, an apparatus of a UE (such as a wireless device 202 that is a UE, as described herein).

Embodiments contemplated herein include a signal as described in or related to one or more elements of the method 400.

Embodiments contemplated herein include a computer program or computer program product comprising instructions, wherein execution of the program by a processor is to cause the processor to carry out one or more elements of the method 400. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

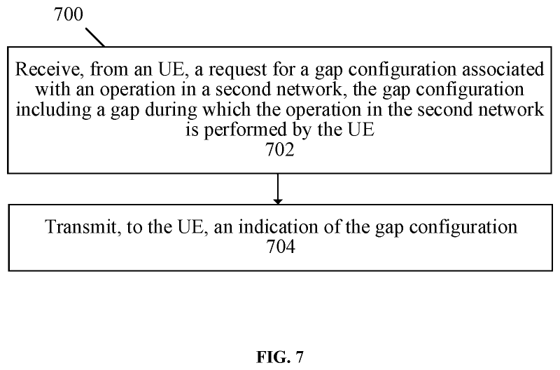

FIG. 7 illustrates a flowchart diagram for an example method 700 at network side for configuration for gap for MUSIMs capable UE, according to embodiments disclosed herein. As shown, the method of FIG. 7 may operate as follows.

At 702, the network device associated with a first network (NW A) receives, from an UE, a request for a gap configuration associated with an operation in a second network, the gap configuration including a gap during which the operation in the second network is performed by the UE.

At 704, the network device associated with the NW A transmits, to the UE, an indication of the gap configuration. Based on the received gap configuration, the UE may perform, during each gap within an operation period, operation in the second network based on the gap configuration, when the UE is in a Radio Resource Control (RRC) connected state with the first network and is in a RRC idle state or RRC inactive state with the second network, the operation period comprising at least one gap. Further, the UE can lengthen the operation period if the gap within the operation period is dropped at the UE due to a collision of the gap with other gaps.

The details of steps of method 700 are similar to those of the steps of the method 400, and thus they are omitted here.

Embodiments contemplated herein include an apparatus comprising means to perform one or more elements of the method 700. This apparatus may be, for example, an apparatus of a base station (such as a network device 218 that is a base station associated with NW A, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 700. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 218 that is a base station, as described herein).

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the UE supports multiple-Universal Subscriber Identity Modules (multi-USIM) including at least a first SIM associated with a first network and a second SIM associated with a second network, and
the at least one radio and the processor are configured to:
request, from the first network, a gap configuration associated with an operation in the second network, the gap configuration including a gap during which the operation in the second network is performed by the UE;
receive, from the first network, an indication of the gap configuration; and
perform, during each gap within an operation period, the operation in the second network based on the gap configuration, when the UE is in a Radio Resource Control (RRC) connected state with the first network and is in a RRC idle state or RRC inactive state with the second network, the operation period comprising at least one gap, and
the processor is further configured to lengthen the operation period if the gap within the operation period is dropped at the UE due to a collision of the gap with other gaps.

2. The UE of claim 1, wherein the operation period is a multiple of an operation window, and the operation window is a multiple of a periodicity of the gap, and
the processor is further configured to lengthen the operation period based on a number of groups of operation window during which one or more gaps are dropped during the operation period.

3. The UE of claim 2, wherein each operation window comprises a plurality of gaps, and
the processor is further configured to lengthen the operation period based on a number of groups of operation window during which all the gaps are dropped during the operation period.

4. The UE of claim 2, wherein the processor is further configured to determine a ratio between the operation window and the periodicity of the gap based on a frequency range of the target cell of the second network, and a Discontinuous Reception (DRX) cycles of a target cell of the second network and the periodicity of the gap.

5. The UE of claim 4, wherein the operation window is a multiple of a maximum of a periodicity of the gap and the DRX cycles.

6. The UE of claim 2, wherein the processor is further configured to determine a ratio between the operation period and the operation window based on a Synchronization Signal Block (SSB) based Measurement Timing configuration (SMTC) periodicity of the target cell of the second network.

7. The UE of claim 2, wherein the processor is further configured to stop lengthening the operation period if the number of groups of operation window during which one or more gap is dropped is larger than a maximum number.

8. The UE of claim 7, wherein the maximum number is determined based on a DRX cycles of a target cell of the second network.

9. The UE of claim 1, wherein the operation comprises performing Radio Resource Management (RRM) measurement on a serving cell in the second network to measure and evaluate the serving cell, and
the operation period comprises a period for the UE to measure and evaluate the serving cell in the second network.

10. The UE of claim 9, wherein the processor is further configured to perform RRM measurement on the serving cell in the second network at least once every limitation period in the operation period.

11. The UE of claim 10, wherein the limitation period is shorter than or equal to the operation period.

12. The UE of claim 11, wherein the processor is further configured to perform cell selection on the second network for the second SIM based on a result of the RRM measurement.

13. The UE of claim 1, wherein the operation comprises performing RRM measurement on an intra-frequency neighbor cell in the second network, and
the operation period comprises at least one of:
a period for the UE to detect an intra-frequency neighbor cell that is newly detectable in the second network (T_{detect, Intra_MUSIM}),
a period for the UE to measure an intra-frequency neighbor cell that is identified and measured in the second network (T_{measure, Intra_MUSIM}), and
a period for the UE to evaluate an intra-frequency neighbor cell that has been detected in the second network (T_{evaluate, Intra_MUSIM}).

14. The UE of claim 1, wherein the operation comprises performing RRM measurement on an inter-frequency neighbor cell in the second network, and
the operation period comprises at least one of:
a period for the UE to detect an inter-frequency neighbor cell that is newly detectable in the second network (T_{detect, Inter_MUSIM}) and a number of inter-frequency carriers indicated by the serving cell in NW B (K_{carrier_MUSIM}),
a period for the UE to measure an inter-frequency neighbor cell that is identified and measured in the second network (T_{measure, Inter_MUSIM}) and a number of inter-frequency carriers indicated by the serving cell in NW B (K_{carrier_MUSIM}), and
a period for the UE to evaluate an inter-frequency neighbor cell that has been detected in the second network (T_{evaluate, Inter_MUSIM}) and a number of inter-frequency carriers indicated by the serving cell in NW B (K_{carrier_MUSIM}).

15. The UE of claim 14, wherein the processor is further configured to perform cell reselection on the second network for the second SIM based on a result of the RRM measurement.

16. A network device associated with a first network, comprising:
at least one antenna;
at least one radio coupled to the at least one antenna; and
a processor coupled to the at least one radio;
wherein the at least one radio and the processor are configured to:
receive, from an UE, a request for a gap configuration associated with an operation in a second network, the gap configuration including a gap during which the operation in the second network is performed by the UE, and
transmit, to the UE, an indication of the gap configuration,
wherein the UE supports multiple-Universal Subscriber Identity Modules (multi-USIM) including at least a first SIM associated with the first network and a second SIM associated with the second network, and
the operation period is lengthened by the UE if the gap within the operation period is dropped at the UE due to a collision of the gap with other gaps.

17. A method, comprising:
by a user equipment (UE),
request, from a first network, a gap configuration associated with an operation in a second network,
wherein the UE supports multiple-Universal Subscriber Identity Modules (multi-USIM) including at least a first SIM associated with the first network and a second SIM associated with the second network, and
the gap configuration including a gap during which the operation in the second network is performed by the UE;
receiving, from the first network, an indication of the gap configuration, and
performing, during each gap within an operation period, operation in the second network based on the gap configuration, when the UE is in a Radio Resource Control (RRC) connected state with the first network and is in a RRC idle state or RRC inactive state with the second network, the operation period comprising at least one gap, and
the processor is further configured to lengthen the operation period if the gap within the operation period is dropped at the UE due to a collision of the gap with other gaps.

18-22. (canceled)
